(19) United States
(12) Patent Application Publication
(10) Pub. No.: US 2024/0357460 A1
(43) Pub. Date: Oct. 24, 2024

(54) METHOD AND APPARATUS FOR CELL RESELECTION IN NON-TERRESTRIAL NETWORK

(71) Applicant: ELECTRONICS AND TELECOMMUNICATIONS RESEARCH INSTITUTE, Daejeon (KR)

(72) Inventors: Seung Kwon CHO, Daejeon (KR); Mi Young YUN, Daejeon (KR); Moon Sik LEE, Daejeon (KR); Jun Hwan LEE, Daejeon (KR)

(73) Assignee: ELECTRONICS AND TELECOMMUNICATIONS RESEARCH INSTITUTE, Daejeon (KR)

(21) Appl. No.: 18/629,353

(22) Filed: Apr. 8, 2024

(30) Foreign Application Priority Data
Apr. 7, 2023 (KR) 10-2023-0046125
May 12, 2023 (KR) 10-2023-0061522

(51) Int. Cl. H04W 36/32; H04W 36/00; H04W 36/08

(52) U.S. Cl. CPC H04W 36/322; H04W 36/0061; H04W 36/0083; H04W 36/083

(57) ABSTRACT

A method of a terminal may comprise: acquiring, from a non-terrestrial network (NTN) base station, system information (SI) including information indicating either a (quasi-) Earth-fixed cell or an Earth-moving cell (EMC); in response to the SI indicating an EMC, calculating a first distance between a location of the terminal and a reference location; and determining whether to perform measurement for cell reselection based on a comparison result between the first distance and a threshold distance included in the SI and ephemeris information of a satellite included in the SI.

### CROSS-REFERENCE TO RELATED APPLICATIONS

This application claims priority to Korean Patent Applications No. 10-2023-0046125, filed on Apr. 7, 2023, and No. 10-2023-0061522, filed on May 12, 2023, with the Korean Intellectual Property Office (KIPO), the entire contents of which are hereby incorporated by reference.

### BACKGROUND

### 1. Technical Field

The present disclosure relates to a cell reselection technique in a wireless communication system, and more particularly, to a cell reselection technique in a non-terrestrial network.

### 2. Related Art

With the development of information and communication technology, various wireless communication technologies have been developed. Typical wireless communication technologies include long term evolution (LTE), new radio (NR), 6th generation (6G) communication, and/or the like. The LTE may be one of 4th generation (4G) wireless communication technologies, and the NR may be one of 5th generation (5G) wireless communication technologies.

For the processing of rapidly increasing wireless data after the commercialization of the 4th generation (4G) communication system (e.g., Long Term Evolution (LTE) communication system or LTE-Advanced (LTE-A) communication system), the 5th generation (5G) communication system (e.g., new radio (NR) communication system) that uses a frequency band (e.g., a frequency band of 6 GHz or above) higher than that of the 4G communication system as well as a frequency band of the 4G communication system (e.g., a frequency band of 6 GHz or below) is being considered. The 5G communication system may support enhanced Mobile BroadBand (eMBB), Ultra-Reliable and Low-Latency Communication (URLLC), and massive Machine Type Communication (mMTC).

Such communication networks can provide communication services to terminals located in terrestrial locations, and therefore can be considered terrestrial networks (TNs). Recently, there has been an increasing demand for communication services not only for communication nodes in terrestrial locations but also for unmanned aerial vehicles, satellites, and the like in non-terrestrial locations. In response to this, technologies for non-terrestrial networks (NTNs) are being discussed by 3GPP.

A terrestrial network, represented as a communication system such as LTE, is a system where both the base stations and terminals that constitute the communication system are in terrestrial locations. On the other hand, a non-terrestrial network refers to a network where at least one of the base stations or terminals is not in a terrestrial location.

The terrestrial network may experience service interruptions in disaster and emergency situations such as fires, earthquakes, and tsunamis. Additionally, in suburban, rural, remote, and maritime areas with low population density, wireless communication service providers may not offer services due to high capital expenditures and operating expenses (CAPEX/OPEX) relative to revenue from low-density demand areas.

The 3GPP standardization meetings are progressing with the standardization of non-terrestrial networks as a way to overcome these limitations of terrestrial networks.

With the progression of non-terrestrial network standardization, efficient cell reselection methods in non-terrestrial networks are required.

### SUMMARY

The present disclosure for resolving the above-described problems is directed to providing a method and an apparatus for cell reselection in a non-terrestrial network.

A method of a terminal, according to a an exemplary embodiment of the present disclosure for achieving the above-described objective, may comprise: acquiring, from a non-terrestrial network (NTN) base station, system information (SI) including information indicating either a (quasi-) Earth-fixed cell or an Earth-moving cell (EMC); in response to the SI indicating an EMC, calculating a first distance between a location of the terminal and a reference location; and determining whether to perform measurement for cell reselection based on a comparison result between the first distance and a threshold distance included in the SI and ephemeris information of a satellite included in the SI.

In the determining of whether to perform measurement for cell reselection, if the first distance is determined to be longer than the threshold distance according to the comparison result but is predicted to decrease based on the ephemeris information of the satellite, the terminal may determine not to perform the measurement for cell reselection.

In the determining of whether to perform measurement for cell reselection, if the first distance is determined to be longer than the threshold distance according to the comparison result and is predicted to increase based on the ephemeris information of the satellite, the terminal may determine to perform the measurement for cell reselection.

The method may further comprise: obtaining terrestrial network (TN) coverage information included in the SI: and determining a TN coverage satisfying a first condition among TN coverages indicated by the TN coverage information as an NTN-only coverage, wherein the first condition is that frequency information associated with the TN coverage information does not exist, or a frequency information list associated with the TN coverage information is empty.

When the SI includes information on a first TN coverage and a second TN coverage, the second TN coverage is determined as the NTN-only coverage, and the terminal is located in an overlapping coverage where the first TN coverage and the second TN coverage overlap, the overlapping coverage may be determined to be the NTN-only coverage.

The method may further comprise: obtaining terrestrial network (TN) coverage information included in the SI: determining whether a measurement initiation condition for TN cell reselection is satisfied based on the SI and the location of the terminal; and in response to determining that the measurement initiation condition is satisfied, performing measurement on TN cells based on the obtained TN coverage information and frequency information associated with TN coverage(s) indicated by the obtained TN coverage information.

The method may further comprise: when the TN coverage information indicates each of a first TN coverage and a second TN coverage, and the location of the terminal is within an overlapping coverage of the first TN coverage and the second TN coverage, obtaining first additional information associated with the first TN coverage and second additional information associated with the second TN coverage; and configuring to use only information common to the first additional information and the second additional information in the overlapping coverage.

Each of the first additional information and the second additional information may include one of frequency information, a frequency list, a frequency band, or a frequency band list

The method may further comprise: obtaining terrestrial network (TN) coverage information included in the SI: in response to that a cell selection condition is satisfied based on the TN coverage information, requesting additional information from the NTN base station; receiving the additional information from the NTN base station; and performing measurement for cell reselection based on the TN coverage information and the additional information.

A method of a non-terrestrial network (NTN), according to a an exemplary embodiment of the present disclosure for achieving the above-described objective, may comprise: broadcasting system information (SI) including information indicating either a (quasi-) Earth-fixed cell or an Earth-moving cell (EMC); receiving, from a terminal, a first message requesting terrestrial network (TN) neighboring cell information including location information of the terminal: generating a second message including the TN neighboring cell information based on the location information of the terminal; and transmitting the second message to the terminal.

The SI may further includes information on a reference location of the satellite, information on a threshold distance, ephemeris information of the satellite, TN coverage information, and additional information associated with TN coverages indicated by the TN coverage information, and the TN coverage information may indicate a first TN coverage and a second TN coverage, and the additional information associated with the TN coverages may include first additional information associated with the first TN coverage and second additional information associated with the second TN coverage.

Each of the first additional information and the second additional information may include one of frequency information, a frequency list, a frequency band, or a frequency band list.

A terminal, according to a an exemplary embodiment of the present disclosure for achieving the above-described objective, may comprise a processor, and the processor may causes the terminal to perform: acquiring, from a non-terrestrial network (NTN) base station, system information (SI) including information indicating either a (quasi-) Earth-fixed cell or an Earth-moving cell (EMC); in response to the SI indicating an EMC, calculating a first distance between a location of the terminal and a reference location; and determining whether to perform measurement for cell reselection based on a comparison result between the first distance and a threshold distance included in the SI and ephemeris information of a satellite included in the SI.

In the determining of whether to perform measurement for cell reselection, if the first distance is determined to be longer than the threshold distance according to the comparison result but is predicted to decrease based on the ephemeris information of the satellite, the processor may cause the terminal to perform: determining not to perform the measurement for cell reselection, and in the determining of whether to perform measurement for cell reselection, if the first distance is determined to be longer than the threshold distance according to the comparison result and is predicted to increase based on the ephemeris information of the satellite, the processor may cause the terminal to perform: determining to perform the measurement for cell reselection.

The processor may further cause the terminal to perform: obtaining terrestrial network (TN) coverage information included in the SI; and determining a TN coverage satisfying a first condition among TN coverages indicated by the TN coverage information as an NTN-only coverage, wherein the first condition is that frequency information associated with the TN coverage information does not exist, or a frequency information list associated with the TN coverage information is empty.

When the SI includes information on a first TN coverage and a second TN coverage, the second TN coverage is determined as the NTN-only coverage, and the terminal is located in an overlapping coverage where the first TN coverage and the second TN coverage overlap, the overlapping coverage may be determined to be the NTN-only coverage. The processor may further cause the terminal to perform: obtaining terrestrial network (TN) coverage information included in the SI: determining whether a measurement initiation condition for TN cell reselection is satisfied based on the SI and the location of the terminal; and in response to determining that the measurement initiation condition is satisfied, performing measurement on TN cells based on the obtained TN coverage information and frequency information associated with TN coverage(s) indicated by the obtained TN coverage information.

The processor may further cause the terminal to perform: when the TN coverage information indicates each of a first TN coverage and a second TN coverage, and the location of the terminal is within an overlapping coverage of the first TN coverage and the second TN coverage, obtaining first additional information associated with the first TN coverage and second additional information associated with the second TN coverage: and using only information common to the first additional information and the second additional information in the overlapping coverage.

Each of the first additional information and the second additional information may include one of frequency information, a frequency list, a frequency band, or a frequency band list.

The processor may further cause the terminal to perform: obtaining terrestrial network (TN) coverage information included in the SI: in response to that a cell selection condition is satisfied based on the TN coverage information, requesting additional information from the NTN base station: receiving the additional information from the NTN base station: and performing measurement for cell reselection based on the TN coverage information and the additional information.

According to exemplary embodiments of the present disclosure, when a terminal in an NTN reselects a TN cell, there is an advantage of being able to prevent unnecessary measurements. Additionally, by preventing unnecessary measurements for TN cell reselection, the terminal has an advantage of avoiding unnecessary power consumption.

Furthermore, when an NTN terminal reselects an NTN cell in an EMC caused by a moving satellite, there is an advantage of preventing unnecessary power consumption by allowing the terminal to avoid unnecessary measurements.

### BRIEF DESCRIPTION OF DRAWINGS

FIG. 1 is a conceptual diagram illustrating a first exemplary embodiment of a non-terrestrial network.

FIG. 2 is a conceptual diagram illustrating a second exemplary embodiment of a non-terrestrial network.

FIG. 3 is a block diagram illustrating a first exemplary embodiment of an entity constituting a non-terrestrial network.

FIG. 4 is a conceptual diagram illustrating various types of non-terrestrial networks considered in 3GPP.

FIG. 5 is a conceptual diagram illustrating a non-terrestrial network, where a base station is located on the ground, as considered in 3GPP.

FIG. 6 is a conceptual diagram illustrating a service coverage of one satellite in a non-terrestrial network.

FIG. 7A is a conceptual diagram of a cell having a fixed location on the ground in a non-terrestrial network.

FIG. 7B is a conceptual diagram illustrating movement of a cell in a non-terrestrial network having a moving satellite.

FIG. 7C is an another conceptual diagram illustrating movement of a cell in a non-terrestrial network having a moving satellite.

FIG. 8 is a conceptual diagram illustrating a case where some coverages overlap among terrestrial network coverages within a non-terrestrial network coverage.

FIG. 9A is a conceptual diagram illustrating a case of expressing a TN coverage using one circle.

FIG. 9B is a conceptual diagram illustrating a case of expressing a TN coverage using three circles.

FIG. 9C is a conceptual diagram illustrating an another case of expressing a TN coverage using three circles.

FIG. 9D is a conceptual diagram illustrating a TN coverage expressed as shown in FIG. 9A and an error coverage corresponding thereto. FIG. 9E is a conceptual diagram illustrating a TN coverage expressed as shown in FIG.

9B and an error coverage corresponding thereto.

FIG. 9F is a conceptual diagram illustrating a TN coverage expressed as shown in FIG. 9C and an error coverage corresponding thereto.

FIG. 10 is a conceptual diagram illustrating a case where a TN coverage included in an NTN coverage overlaps with a portion of an NTN-only coverage.

FIG. 11A is a conceptual diagram illustrating a TN coverage and an NTN-only coverage using circles.

FIG. 11B is a conceptual diagram illustrating an error coverage of FIG. 11A.

FIG. 12 is a sequence chart illustrating a measurement initiation procedure for TN cell reselection.

FIG. 13A is a conceptual diagram illustrating a terminal location at a first time in an NTN where a satellite moves.

FIG. 13B is a conceptual diagram illustrating a terminal location at a second time in the NTN where the satellite moves.

### DETAILED DESCRIPTION OF THE EMBODIMENTS

Since the present disclosure may be variously modified and have several forms, specific exemplary embodiments will be shown in the accompanying drawings and be described in detail in the detailed description. It should be understood, however, that it is not intended to limit the present disclosure to the specific exemplary embodiments but, on the contrary, the present disclosure is to cover all modifications and alternatives falling within the spirit and scope of the present disclosure.

Relational terms such as first, second, and the like may be used for describing various elements, but the elements should not be limited by the terms. These terms are only used to distinguish one element from another. For example, a first component may be named a second component without departing from the scope of the present disclosure, and the second component may also be similarly named the first component. The term “and/or” means any one or a combination of a plurality of related and described items.

In exemplary embodiments of the present disclosure, “at least one of A and B” may refer to “at least one of A or B” or “at least one of combinations of one or more of A and B”. In addition, “one or more of A and B” may refer to “one or more of A or B” or “one or more of combinations of one or more of A and B”.

When it is mentioned that a certain component is “coupled with” or “connected with” another component, it should be understood that the certain component is directly “coupled with” or “connected with” to the other component or a further component may be disposed therebetween. In contrast, when it is mentioned that a certain component is “directly coupled with” or “directly connected with” another component, it will be understood that a further component is not disposed therebetween.

The terms used in the present disclosure are only used to describe specific exemplary embodiments, and are not intended to limit the present disclosure. The singular expression includes the plural expression unless the context clearly dictates otherwise. In the present disclosure, terms such as ‘comprise’ or ‘have’ are intended to designate that a feature, number, step, operation, component, part, or combination thereof described in the specification exists, but it should be understood that the terms do not preclude existence or addition of one or more features, numbers, steps, operations, components, parts, or combinations thereof.

Unless otherwise defined, all terms (including technical and scientific terms) used herein have the same meaning as commonly understood by one of ordinary skill in the art to which this disclosure belongs. Terms that are generally used and have been in dictionaries should be construed as having meanings matched with contextual meanings in the art. In this description, unless defined clearly, terms are not necessarily construed as having formal meanings.

Hereinafter, exemplary embodiments of the present disclosure will be described in greater detail with reference to the accompanying drawings. In order to facilitate general understanding in describing the present disclosure, the same components in the drawings are denoted with the same reference signs, and repeated description thereof will be omitted.

A communication network to which exemplary embodiments according to the present disclosure are applied will be described. The communication system may be a non-terrestrial network (NTN), a 4G communication network (e.g., long-term evolution (LTE) communication network), a 5G communication network (e.g., new radio (NR) communication network), a 6G communication network, or the like. The 4G communication network, 5G communication network, and 6G communication network may be classified as terrestrial networks, when base stations and terminals are all located in terrestrial locations.

The NTN may operate based on the LTE technology and/or the NR technology. The NTN may support communications in frequency bands below 6 GHz as well as in frequency bands above 6 GHz. The 4G communication network may support communications in the frequency band below 6 GHz. The 5G communication network may support communications in the frequency band below 6 GHz as well as in the frequency band above 6 GHZ. The communication network to which the exemplary embodiments according to the present disclosure are applied is not limited to the contents described below, and the exemplary embodiments according to the present disclosure may be applied to various communication networks. Here, the communication network may be used in the same sense as the communication system.

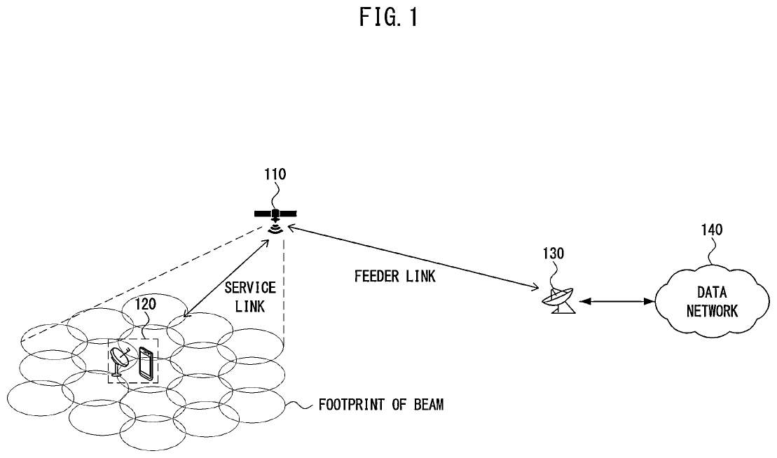

FIG. 1 is a conceptual diagram illustrating a first exemplary embodiment of a non-terrestrial network.

Referring to FIG. 1, a non-terrestrial network (NTN) may include a satellite 110, a communication node 120, a gateway 130, a data network 140, and the like. The NTN shown in FIG. 1 may be an NTN based on a transparent payload. The satellite 110 may be a low earth orbit (LEO) satellite (at an altitude of 300 to 1,500 km), a medium earth orbit (MEO) satellite (at an altitude of 7,000 to 25,000 km), a geostationary earth orbit (GEO) satellite (at an altitude of about 35,786 km), a high elliptical orbit (HEO) satellite, or an unmanned aircraft system (UAS) platform. The UAS platform may include a high altitude platform station (HAPS).

The communication node 120 may include a communication node (e.g., a user equipment (UE) or a terminal) located on a terrestrial site and a communication node (e.g., an airplane, a drone) located on a non-terrestrial space. A service link may be established between the satellite 110 and the communication node 120, and the service link may be a radio link. The satellite 110 may provide communication services to the communication node 120 using one or more beams. The shape of a footprint of the beam of the satellite 110 may be elliptical.

The communication node 120 may perform communications (e.g., downlink communication and uplink communication) with the satellite 110 using LTE technology and/or NR technology. When dual connectivity (DC) is supported, the communication node 120 may be connected to other base stations (e.g., base stations supporting LTE and/or NR functionality) as well as the satellite 110, and perform DC operations based on the techniques defined in the LTE and/or NR specifications.

The gateway 130 may be located on a terrestrial site, and a feeder link may be established between the satellite 110 and the gateway 130. The feeder link may be a radio link. The gateway 130 may be referred to as a ‘non-terrestrial network (NTN) gateway’. The gateway 130 may be connected to the data network 140. There may be a ‘core network’ between the gateway 130 and the data network 140. In this case, the gateway 130 may be connected to the core network, and the core network may be connected to the data network 140.

The core network may support the NR technology. For example, the core network may include an access and mobility management function (AMF), a user plane function (UPF), a session management function (SMF), and the like.

Alternatively, a base station and the core network may exist between the gateway 130 and the data network 140. In this case, the gateway 130 may be connected with the base station, the base station may be connected with the core network, and the core network may be connected with the data network 140. The base station and core network may support the NR technology.

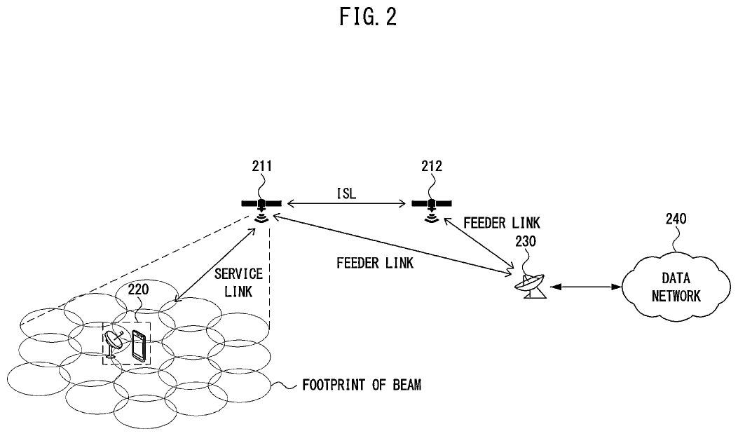

FIG. 2 is a conceptual diagram illustrating a second exemplary embodiment of a non-terrestrial network.

Referring to FIG. 2, a non-terrestrial network may include a first satellite 211, a second satellite 212, a communication node 220, a gateway 230, a data network 240, and the like. The NTN shown in FIG. 2 may be a regenerative payload based NTN. For example, each of the satellites 211 and 212 may perform a regenerative operation (e.g., demodulation, decoding, re-encoding, re-modulation, and/or filtering operation) on a payload received from other entities (e.g., the communication node 220 or the gateway 230), and transmit the regenerated payload.

Each of the satellites 211 and 212 may be a LEO satellite, a MEO satellite, a GEO satellite, a HEO satellite, or a UAS platform. The UAS platform may include a HAPS. The satellite 211 may be connected to the satellite 212, and an inter-satellite link (ISL) may be established between the satellite 211 and the satellite 212. The ISL may operate in an RF frequency band or an optical band. The ISL may be established optionally. The communication node 220 may include a terrestrial communication node (e.g., UE or terminal) and a non-terrestrial communication node (e.g., airplane or drone). A service link (e.g., radio link) may be established between the satellite 211 and communication node 220. The satellite 211 may provide communication services to the communication node 220 using one or more beams.

The communication node 220 may perform communications (e.g., downlink communication or uplink communication) with the satellite 211 using LTE technology and/or NR technology. When DC is supported, the communication node 220 may be connected to other base stations (e.g., base stations supporting LTE and/or NR functionality) as well as the satellite 211, and may perform DC operations based on the techniques defined in the LTE and/or NR specifications.

The gateway 230 may be located on a terrestrial site, a feeder link may be established between the satellite 211 and the gateway 230, and a feeder link may be established between the satellite 212 and the gateway 230. The feeder link may be a radio link. When the ISL is not established between the satellite 211 and the satellite 212, the feeder link between the satellite 211 and the gateway 230 may be established mandatorily.

The gateway 230 may be connected to the data network 240. There may be a core network between the gateway 230 and the data network 240. In this case, the gateway 230 may be connected to the core network, and the core network may be connected to the data network 240. The core network may support the NR technology. For example, the core network may include AMF, UPF, SMF, and the like.

Alternatively, a base station and the core network may exist between the gateway 230 and the data network 240. In this case, the gateway 230 may be connected with the base station, the base station may be connected with the core network, and the core network may be connected with the data network 240. The base station and the core network may support the NR technology.

Meanwhile, entities (e.g., satellites, communication nodes, gateways, etc.) constituting the NTNs shown in FIGS. 1 and 2 may be configured as follows.

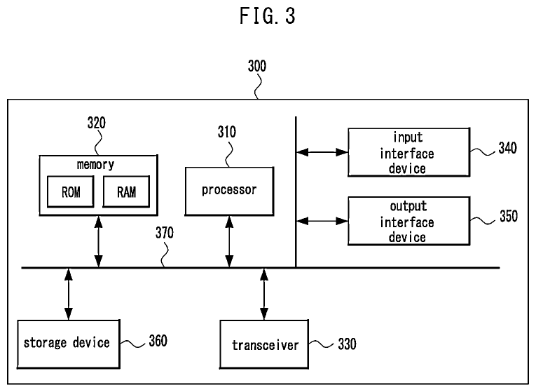

FIG. 3 is a block diagram illustrating a first exemplary embodiment of an entity constituting a non-terrestrial network.

Referring to FIG. 3, an entity 300 may include at least one processor 310, a memory 320, and a transceiver 330 connected to a network to perform communication. In addition, the entity 300 may further include an input interface device 340, an output interface device 350, a storage device 360, and the like. The components included in the entity 300 may be connected by a bus 370 to communicate with each other.

However, each component included in the entity 300 may be connected to the processor 310 through a separate interface or a separate bus instead of the common bus 370. For example, the processor 310 may be connected to at least one of the memory 320, the transceiver 330, the input interface device 340, the output interface device 350, and the storage device 360 through a dedicated interface.

The processor 310 may execute at least one instruction stored in at least one of the memory 320 and the storage device 360. The processor 310 may refer to a central processing unit (CPU), a graphics processing unit (GPU), or a dedicated processor on which the methods according to the exemplary embodiments of the present disclosure are performed. Each of the memory 320 and the storage device 360 may be configured as at least one of a volatile storage medium and a nonvolatile storage medium. For example, the memory 320 may be configured with at least one of a read only memory (ROM) and a random access memory (RAM).

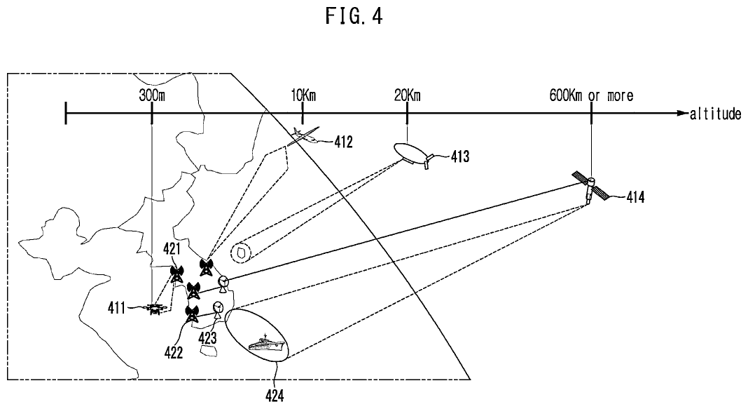

FIG. 4 is a conceptual diagram illustrating various types of non-terrestrial networks considered in 3GPP.

Referring to FIG. 4, a horizontal-axis arrow may indicate an example of an altitude of a corresponding type of network. An unmanned aerial vehicle (UAV) 411 may provide communication services to terrestrial stations (or terminals) at a low altitude of about 300 m, an airplane 412 may communicate with terrestrial stations (or terminals) at an altitude of about 10 km, a high-altitude platform station (HAPS) 413 may communicate with terrestrial stations (or terminals) at an altitude of about 20 km, and a satellite 414 may communicate with terrestrial stations (or terminals) at an altitude of about 600 km. The satellite 414 in FIG. 4 may be an example of an LEO satellite. MEO satellites, GEO satellites, or HEO satellites may have higher altitudes than the satellite 414 illustrated in FIG. 4.

In FIG. 4, the satellite 414 or HAPS 413 may be connected to a terrestrial station 422 through a gateway 423. For the gateway connected to the HAPS 413, a reference numeral is omitted for simplicity. It should be noted that reference numerals of terrestrial stations and gateways are omitted in FIG. 4 for simplicity of drawing. FIG. 4 illustrates an example in which a communication node for which a service link is established with the satellite 414 is also located on a ship 424.

As illustrated in FIG. 4, a non-terrestrial network (NTN) considered in 3GPP may be configured by locating a base station on the HAPS 413 or by locating a base station on the satellite 414.

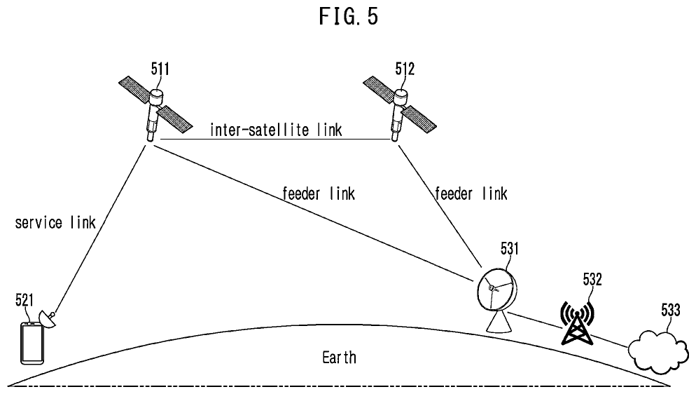

FIG. 5 is a conceptual diagram illustrating a non-terrestrial network, where a base station is located on the ground, as considered in 3GPP.

A form illustrated in FIG. 5 can be understood as the same form as that previously described in FIG. 2. An inter-satellite link (ISL) may be established between a first satellite 511 and a second satellite 512, and each of the first satellite 511 and the second satellite 512 has a feeder link with a gateway 531. In the example of FIG. 5, a service link is illustrated only between the first satellite 511 and a terminal 521, but the second satellite 512 may also have a service link with the terminal. A gateway 531 may be connected to a core network 533 through a base station 532. The core network 533 illustrated in FIG. 5 may correspond to the data network 240 described in FIG. 2.

The scope of ‘location of base station’ in the 3GPP standardization organization may be exemplified as follows.

First, as illustrated in FIGS. 2 and/or 5, a base station may be located on the ground. If a base station is located on the ground, signals transmitted/received between a satellite and a terminal may be transmitted/received through the base station on the ground.

As an example, the terminal 521 may establish the service link with the first satellite 511. Signals (or data) transmitted/received between the terminal 521 through the service link may be transmitted/received through the feeder link between the first satellite 511 and the gateway 531, a link between the gateway 531 and the base station 532, and a link between the base station 532 and the core networks 533.

As another example, signals (or data) transmitted/received between the terminal 521 and the first satellite 511 through the service link may be transmitted and received through an ISL between the first satellite 511 and the second satellite 512, a feeder link between the second satellite 512 and the gateway 531, a link between the gateway 531 and the base station 532, and a link between the base station 532 and the core network 533.

Second, in the examples of FIG. 2 and/or FIG. 5, the case where the base station is located on the satellite may include a case where some or all of functions of the base station are located on the satellites 511 and 512. As an example, a part of the functions of the base station or all of the functions of the base station may be located in each of the satellites 511 and 512. As another example, a part of the functions of the base station or the entire functions of the base station may be located in the satellites 511 and 512 as being split.

Third, in the examples of FIG. 2 and/or FIG. 5, the case where the base station is located on the satellite may include a case where the entire functions of the base station and a part or all of functions of the core network 533 are located on the satellite. As an example, all or part of the functions of the base station and the core network 533 may be located in each of the satellites 511 and 512. As another example, all or part of the functions of the base station and the core network 533 may be located in the satellites 511 and 512 as being split.

Terrestrial network (TNs) can provide services with lower latency and higher data rates to terminals compared to NTNs. In addition, TNs can provide services to users at a much lower price than NTNs, even if a service quality is the same. For a terminal connected to an NTN, if it is within a service coverage of a TN, it may be advantageous to use the TN.

For the above reasons, 3GPP is in the process of standardizing how a terminal using an NTN can connect to a TN when the TN is available.

For terminal mobility in most wireless communication systems of TNs, a terminal in an idle mode may measure neighboring cells and reselect a cell to camp on based on measurement results. Even for a terminal in the idle mode or inactive mode in an NTN, the mobility of the terminal can be supported by the measurement and reselection mechanism for TNs.

In case of a handover, which is a mobility support mechanism for a terminal in a connected mode in a wireless communication system of a TN, a time during which services provided to the terminal are interrupted due to the handover (e.g. handover interruption time) may occur. When establishing standards for handover schemes in wireless communication systems in TNs, one of key considerations is reducing the handover interruption time. In addition, for a terminal in the idle mode or inactive mode, one of key considerations for saving power in a wireless communication system of a TN is power efficiency.

An NTN terminal may also have capability to communicate with TNs. Additionally, a terminal capable of communicating with TNs may be in one of the idle mode, inactive mode, or connected mode in terms of connection with the NTN. When the NTN terminal capable of communicating with TNs is in the idle mode or inactive mode, the measurement and reselection mechanism performed for the wireless communication systems of TNs may not be appropriate for power conservation. This reason is due to the characteristics of NTNs that are different from those of TNs.

FIG. 6 is a conceptual diagram illustrating a service coverage of one satellite in a non-terrestrial network.

In non-terrestrial communications, a radius of a coverage served by one satellite may range from a minimum of tens of kilometers to a maximum of hundreds or thousands of kilometers. FIG. 6 illustrates a coverage served by one satellite in Korea. A reference numeral 611 may indicate an example of a service coverage of an LEO satellite, and a reference numeral 621 may indicate an example of a service coverage of a GEO satellite. A radius 611 of the service coverage of the LEO satellite may be, for example, 100 km, and a radius 621 of the service coverage of the GEO satellite may be about 1000 km.

As illustrated in FIG. 6, the coverage served by one satellite may be as small as one province of the Republic of Korea, or may include an area of one country or several countries.

In this wide NTN service coverage, a coverage of a TN may occupy only a small portion. In FIG. 6, most areas within the radius 621 of the service coverage of the GEO satellite may be oceans where TNs are not available. In this case, if an NTN terminal in the idle mode or inactive mode continues to measure neighboring cells belonging to TNs in order to reselect a TN, a problem arises in that unnecessary measurements are almost always continued.

Considering the wide NTN service coverage as illustrated in FIG. 6, the NTN terminal in the idle mode or inactive mode may experience unnecessary measurements for cell reselection for a long time. The unnecessary measurements for a long period of time for cell reselection increase the power consumption of the terminal, which runs counter to power saving, which is a key consideration in the idle mode or inactive mode.

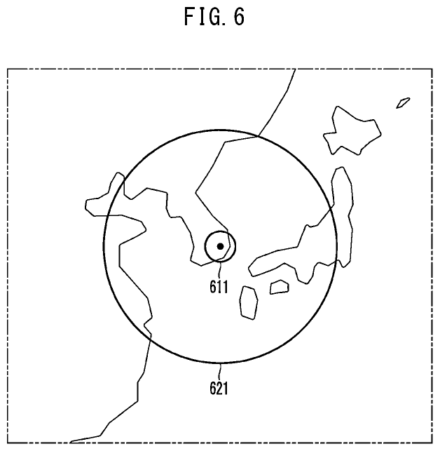

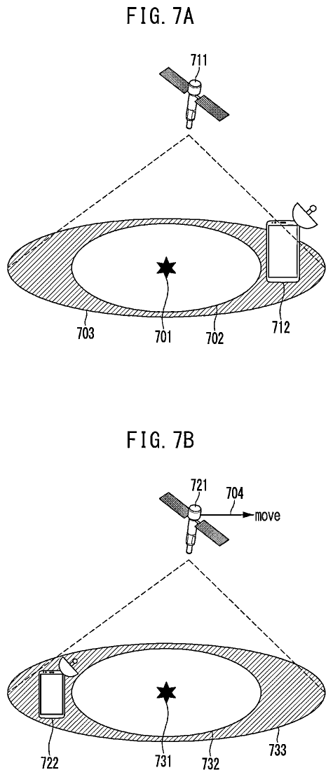

FIG. 7A is a conceptual diagram of a cell having a fixed location on the ground in a non-terrestrial network, FIG. 7B is a conceptual diagram illustrating movement of a cell in a non-terrestrial network having a moving satellite, and FIG. 7C is an another conceptual diagram illustrating movement of a cell in a non-terrestrial network having a moving satellite.

An NTN illustrated in FIG. 7A has a cell at a fixed location. In the present disclosure described below, a ‘cell at a fixed location’ may include one or both of an Earth-fixed cell and a quasi-Earth-fixed cell. It should be noted that a ‘cell at a fixed location’ may be referred to as a ‘fixed cell’ and may be expressed in various forms in other documents. A reference numeral 703 may indicate a cell coverage of a satellite 711, and the cell coverage 703 may include a first service coverage 702 within a preset distance threshold from a reference location 701. The cell coverage 703 may include a second service coverage that does not overlap the first service coverage, and in FIG. 7A, the second service coverage may correspond to a hatched portion.

The 3GPP NTN may have a location-based measurement initiation condition. In the example of FIG. 7A, the first service coverage may have a form of a circle whose radius is a distance threshold value from the reference location of the cell. The reference location 701 of the cell may be included along with the threshold distance value in a system information block (SIB) (e.g. SIB19) broadcast by the NTN. The reference location 701 of the cell may represent a location within the cell and may be a point that serves as a reference for the distance-based measurement initiation condition.

According to the current 3GPP technical specifications, an NTN terminal in the idle mode or inactive mode needs to initiate measurement when its distance to the reference location 701 exceeds a threshold value. In other words, in FIG. 7A, the terminal 712 needs to initiate measurement when located in the second service coverage. The second service coverage may be an area that is at or beyond the threshold distance from the reference location 701. The reason why the measurement initiation point is at or beyond the threshold distance from the reference location 701 is that, unlike in TNs, a difference in received signal strength between a cell center and a cell edge in the NTN is not large. If the same measurement initiation condition as for TNs, for example, a received signal strength, is applied to the NTN terminal, a problem may arise where the terminal 712 delays the initiation of measurement for cell reselection or does not perform measurement for cell reselection. Meanwhile, according to the current 3GPP technical specifications, distance-based measurement initiation only considers cells with fixed cell coverages on the ground (e.g. Earth-fixed cells and quasi-Earth-fixed cells).

Recently, 3GPP is also working on standardizing a cell (e.g. Earth-moving cell, EMC) whose cell coverage on the ground moves with movement of the satellite. FIGS. 7B and 7C illustrate two examples of distance-based measurement initiation for EMC.

FIGS. 7B and 7C are conceptual diagrams illustrating cases where locations of terminals 722 and 723 are different, and the same satellite 721 moves in the same direction. Referring to FIGS. 7B and 7C, a direction of an arrow 704 may indicate a direction of movement of the satellite 721. As the satellite 721 moves, an EMC 733 may also move together. The satellite 721 may provide information on a reference location 731 of a cell and a threshold distance (e.g. threshold distance value) to each of the terminals 722 and 723 using SIB 19. Each of the terminals 722 and 723 may receive the SIB19 and obtain information on the reference location 731 of the cell and threshold distance (e.g. threshold distance value) from the SIB19. In FIG. 7B, the reference location 731 of the cell may be designated as a specific location within the cell covered by the satellite 721.

A reference numeral 733 may indicate a cell coverage of the satellite 721, and the cell coverage 733 may include a first service coverage 732 within the preset threshold distance from the reference location 731. The cell coverage 733 may include a second service coverage that does not overlap the first service coverage 732, and the second service coverage may correspond to a hatched portion.

The cases of FIGS. 7B and 7C may correspond to cases where each of the terminals 722 and 723 receives the SIB19 and has a measurement initiation condition based on the reference location 731 and the threshold distance value included in the SIB19. In other words, each of the terminals 722 and 723 located in the second service coverage may initiate measurement. The satellite 721 with an EMC may use only fixed beams when providing services to terminals (or gateway) within the cell. Therefore, as the satellite 721 moves, the coverage of EMC may also move in the same direction as the satellite.

In the case shown in FIG. 7B, as the coverage of EMC moves, the terminal 722 may leave the EMC. Additionally, the terminal 722 may confirm that it is located in the second service coverage based on the SIB19 and initiate measurement for cell reselection. The terminal 722 may reselect one of measured neighboring cells.

In the case shown in FIG. 7C, as the coverage of the EMC moves, the terminal 723 may be located near a center of the EMC. The terminal 723 may also confirm that it is located in the second service coverage based on the SIB 19, and initiate measurement for cell reselection. However, unlike the case of FIG. 7B, in the case shown in FIG. 7C, even if the terminal 723 performs measurement for reselection of a neighboring cell, the terminal may not leave the cell but rather approaches the center of the cell, eliminating the need for cell reselection. In other words, in the case shown in FIG. 7C, performing measurement for reselection of a neighboring cell by the terminal 723 may be unnecessary.

As described above, if the same distance-based measurement initiation condition as for GEO satellites are applied even when the satellite is moving, the terminal may perform unnecessary measurements. Performing unnecessary measurements increases the power consumption of the terminal, and if this phenomenon is repeated, the power consumption may increase further.

Hereinafter, a method and procedure for a terminal in the idle mode or inactive mode in an NTN to reselect a TN cell according to the present disclosure will be described.

### (1) Method of Expressing TN Coverage Information

An NTN may transmit (or broadcast) information on TN coverages included within a coverage of the NTN. Here, ‘TN coverage information’ may be referred to as information on TN cell coverages included in the coverage of the NTN. The TN coverage information may include information on one cell coverage or two or more cell coverages belonging to TN(s). In other words, the TN coverage information may be information on a union of TN cell coverages that at least partially overlap with the coverage of the NTN.

### (2) Method of Delivering TN Coverage Information and Additional Information

The TN coverage information according to the present disclosure may include information on one or two or more TN coverages configured within the coverage covered by the satellite of the NTN. However, when a moving satellite forming an EMC is moving in an area where TNs do not exist, such as when passing over the Pacific ocean, the satellite may report that a TN coverage does not exist.

The TN coverages may be represented by a list of absolute coordinates. The NTN may transmit the TN coverage information to terminals. The NTN terminal(s) may receive the TN coverage information from the NTN. In this case, the terminal(s) may be in one of the idle mode, inactive mode, or connected mode.

Hereinafter, specific schemes in which the NTN transmits the TN coverage information to terminals will be described.

Scheme 1: The NTN base station may transmit the TN coverage information to terminals by broadcasting the TN coverage information. For example, the NTN base station may broadcast the TN coverage information using SIB(s). Each terminal may acquire the TN coverage information by receiving a signal, for example, the SIB, broadcast by the NTN base station.

Scheme 2: The terminal may request TN coverage information from the NTN base station. The NTN base station may transmit a response message for the terminal's request to the terminal by including the TN coverage information in the response message. Here, the information included in the response message may be information that is not included in the information broadcast by the base station. For example, the information included in the response message may be TN coverage information with higher accuracy than the broadcast information. For example, in case of the EMC, the TN coverage information included in the response message may be the most recent TN coverage information based on a time at which the base station receives the request message from the NTN terminal. When the terminal in the idle or inactive mode requests TN coverage information from the NTN base station according to Scheme 2, the terminal in the idle terminal or inactive terminal may transition to the connected mode (e.g. radio resource control (RRC) connected mode).

The terminal that has transitioned to the connected mode may initiate a random access (RA) procedure to the NTN base station to request TN coverage information. The terminal that has transitioned to the connected mode may transmit a message requesting TN coverage information to the NTN base station after the RA procedure. The message requesting TN coverage information may be, for example, an RRC layer message. When the NTN base station receives the message requesting TN coverage information from the terminal, it may transmit a response message to the corresponding terminal. The response message may be, for example, an RRC layer message and may include TN coverage information.

In the above description, Scheme 1 and Scheme 2 have been described separately, but Scheme 1 and Scheme 2 may also be used together. For example, an NTN terminal may receive TN coverage information according to Scheme 1. The terminal receiving the TN coverage information according to Scheme 1 may request additional TN coverage information from the NTN base station according to Scheme 2 depending on a specific condition or need. The specific condition may be a condition for cell selection. In other words, if the condition for cell selection is satisfied, the terminal receiving the TN coverage information according to Scheme 1 may request additional TN coverage information from the NTN base station according to Scheme 2 in order to obtain more accurate information. The terminal may receive additional information from the NTN base station. When the additional information is received, the terminal may perform a procedure for cell reselection based on the TN coverage information obtained according to Scheme 1 and the additional information received according to Scheme 2.

The NTN base station may further transmit (or broadcast) additional information related to the TN coverage information to the terminal in addition to the TN coverage information. The terminal may receive the additional information related to the TN coverage information from the NTN base station.

The additional information transmitted (or broadcast) by the NTN base station to the terminal may include information on frequency (ies) related to the respective TN coverages (or, usable in the respective TN coverages).

### (3) Determination of Information on Overlapping TN Coverages

According to the TN coverage information transmitted (or broadcast) by the NTN, TN coverage(s) may overlap with each other. The terminal may need to be able to determine which TN to use when the terminal is located in a region where TN coverages overlap.

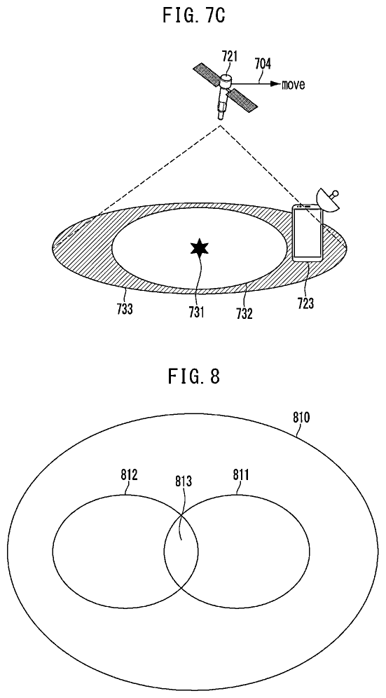

FIG. 8 is a conceptual diagram illustrating a case where some coverages overlap among terrestrial network coverages within a non-terrestrial network coverage.

Referring to FIG. 8, an NTN coverage 810 may be a service coverage configured by one satellite, and each of TN coverages 811 and 812 may be a coverage served by at least one base station or two or more base stations. In the example of FIG. 8, for convenience of description, each service coverage 810, 811, or 812 is illustrated in form of a circle.

As illustrated in FIG. 8, the TN coverage 811 and 812 may include a specific coverage region 813 in common. The TN coverage A 811 may be a coverage served by a TN A, and the TN coverage B 812 may be a coverage served by a TN B. In this case, the overlapping coverage 813 may be a coverage served by both the TN A and TN B. In the following description, the overlapping coverage served by both the TN A and TN B will be expressed as ‘TN coverage {A∩B}’. Here, ‘TN’ may mean a terrestrial network.

In the present disclosure, ‘TN-related information’ may include the above-described TN coverage information and additional information associated therewith. The TN-related information may include information on frequency (ies) related to the respective TN coverages (or, usable in the respective terrestrial network coverages).

Depending on a scheme of interpreting information related to ‘TN coverage {A∩B}’, confusion may arise as to what the information related to ‘TN coverage {A∩B}’ is.

Assuming that the TN-related information is a frequency band list, a situation of the confusion on the information related to ‘TN coverage {A∩B}’ may be described as follows.

It may be assumed that a frequency band list based on information related to the TN A is {b1, b2}, and a frequency band list based on information related to the TN B is {b2, b3}. In this case, confusion may arise as to which frequency band list is associated with the TN coverage {A∩B}. For example, depending on an interpretation scheme, the frequency band list associated with the TN coverage {A∩B} may be interpreted as {b2}, or the frequency band list associated with the TN coverage {A∩B} may be interpreted as {b1, b2}, {b2, b3} or {b1, b2, b3}.

In the above-described example, as compared to the case where the frequency band list associated with the TN coverage {A∩B} is interpreted as {b2}, the case where the frequency band list associated with the TN coverage {A∩B} is interpreted as {b1, b2, b3} may correspond to a case of having a list of frequency bands three times as large. Therefore, if the terminal interprets that more frequency bands are related than the actual related frequency bands, the terminal may perform measurement operations for TN cell reselection in unnecessary bands. Due to such the excessive measurements for TN cell reselection, the terminal may consume unnecessary power.

Hereinafter, a method according to the present disclosure for determining information with respect to overlapping TN coverages to avoid unnecessary measurements and power waste. A method according to the present disclosure described below can prevent the confusing situation described above and prevent unnecessary measurements.

In the present disclosure, information associated with an overlapping coverage may be defined as common information associated with each of the overlapping TN coverages. According to the definition of the present disclosure, the frequency band list associated with the TN coverage {A∩B} may be {b2} in the above-described assumption.

(4) Method of Expressing a Coverage Supporting only NTN

A coverage where only NTNs are supported may use TN coverage information.

The TN coverage information may be broadcast as system information (SI). The SI may include various information. For example, the SI may include the reference location and distance threshold described above. The SI may include information on a cell formed by a satellite, for example, information indicating one of a fixed cell or EMC. In addition, information included in the SI will be further described below. However, in the present disclosure, all information included in the SI will not be listed.

Since the SI is broadcast information, the amount of information that can be included in the SI may be limited. When broadcasting the TN coverage information using the SI, a method of expressing the TN coverage information as one or two or more circles may be considered. Due to limitations on the amount of information that can be included in SI, the number of circles expressible by the SI may also be limited to a certain number or less.

Due to the nature of a circle, there may be significant limitations in accurately representing a TN coverage. In addition, due to limitations on the amount of information that can be included in the SI, it may be difficult for the TN coverage information included in the SI to include information on a large number of circles. The TN coverages based on information of circles included in the SI will be described with reference to the attached drawings.

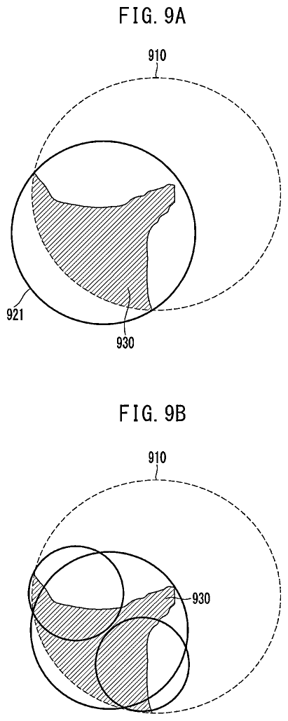

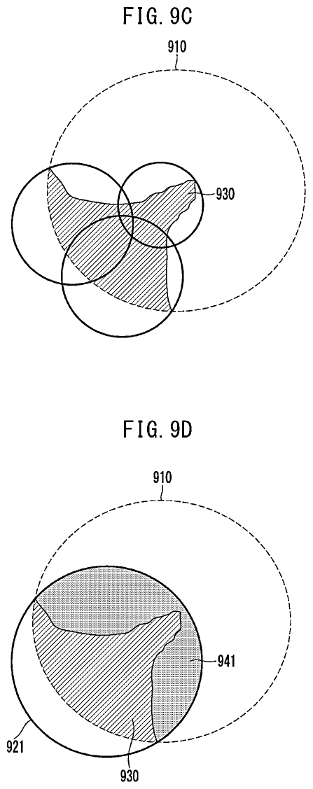

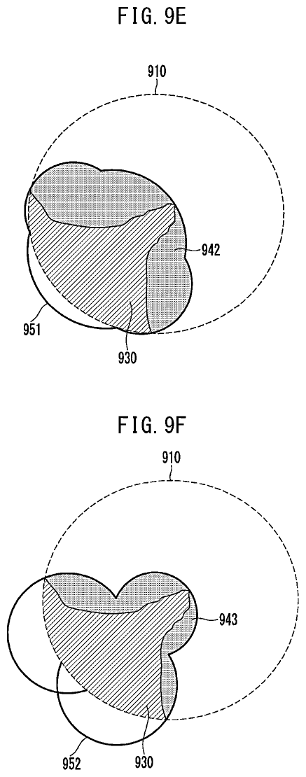

FIG. 9A is a conceptual diagram illustrating a case of expressing a TN coverage using one circle.

Referring to FIG. 9A, a TN coverage 930 may be included within an NTN coverage 910 covered by a satellite. When the TN coverage 930 is expressed as a single circle, it may have a form indicated by a reference numeral 921. Information on the circle may consist of a center and a radius of the circle. When the TN coverage 930 is expressed with one circle, a portion that does not belong to the TN coverage 930 may be significantly included in the one circle.

FIG. 9B is a conceptual diagram illustrating a case of expressing a TN coverage using three circles, and FIG. 9C is a conceptual diagram illustrating an another case of expressing a TN coverage using three circles.

In the present disclosure below, error coverages corresponding to cases where an NTN coverage is recognized as a TN coverage will be described with reference to FIGS. 9A to 9C.

FIG. 9D is a conceptual diagram illustrating a TN coverage expressed as shown in FIG. 9A and an error coverage corresponding thereto, FIG. 9E is a conceptual diagram illustrating a TN coverage expressed as shown in FIG. 9B and an error coverage corresponding thereto, and FIG. 9F is a conceptual diagram illustrating a TN coverage expressed as shown in FIG. 9C and an error coverage corresponding thereto.

Referring to FIG. 9D, the TN coverage 930 may be included in the NTN coverage 910 covered by the satellite, and the TN coverage 930 may be expressed using one circle. Compared to the actual TN coverage 930, the TN coverage expressed by one circle 921 may include an error coverage 941. As shown in FIG. 9D, it can be seen that there is a very wide error coverage 941 when the TN coverage 930 within the NTN coverage 910 is expressed using one circle.

Referring to FIG. 9E, the TN coverage 930 may be included in the NTN coverage 910 covered by the satellite, and the TN coverage 930 may be expressed using three circles. Compared to the actual terrestrial network coverage 930, the TN coverage 951 expressed by three circles may also include an error coverage 942. Comparing the error coverage 941 of FIG. 9D, in which the TN coverage 930 is expressed using one circle, with the error coverage 942 of FIG. 9E, in which the TN coverage 930 is expressed three circles, it can be seen that the size of the error coverage 942 in FIG. 9E is not significantly reduced despite using three circles.

Referring to FIG. 9F, the TN coverage 930 may be included in the NTN coverage 910 covered by the satellite, and the TN coverage 930 may be expressed using three circles. Compared to the actual TN coverage 930, the TN coverage 951 expressed by three circles may also include an error coverage 943. It can be seen that the size of the error coverage 943 in FIG. 9F is significantly reduced as compared to the error coverages 941 and 942 of FIGS. 9D and 9E.

Through the examples of FIGS. 9D to 9F, it can be seen that the error coverages 941, 942, and 943 that the terminal may incorrectly determine to be the TN coverage 930 are quite large coverages. The large error coverages 941, 942, and 943 may mean that the terminal performs more unnecessary measurements to reselect a TN cell. Therefore, the smaller the coverage that the terminal misjudges, the higher the power saving effect of the terminal.

Through the examples of FIGS. 9D to 9F, it can be identified that the error coverages 941, 942, and 943 can be further reduced only by using a large number of circles and appropriately selecting centers and radiuses of the circles. However, limitations may still exist due to the geometric characteristics of circles.

The present disclosure provides a method to achieve the objective of overcoming the limitation on the number of circles that can be expressed in the SI and the limitation of the geometric shape of circles. According to exemplary embodiments of the present disclosure, it can be made possible to prevent unnecessary measurements by expressing the TN network coverage 1130 more accurately, thereby increasing the power saving effect of the terminal.

For the purpose of overcoming the limitation on the number of circles and overcoming the limitation of the geometric shape of circles, an NTN-only coverage may be defined, and information on the NTN-only coverages may be provided to terminals. Additionally, according to the present disclosure, the NTN-only coverage may be defined as an area that is not covered by a TN.

In addition, in order to overcome limitations on the number of circles and limitations on the geometric shape of circles, the present disclosure provides a method for more efficiently expressing the NTN-only coverages as follows.

According to the present disclosure, the NTN-only coverage may refer to an area (or region) without associated frequency information or with an empty associated frequency information list among areas expressed as TN coverages. An area without associated frequency information or with an empty associated frequency list among TN coverages may indicate that the corresponding area is not a TN coverage.

An NTN base station may broadcast TN coverage information and information on frequency (ies) associated therewith using the SI, and a specific information element (IE) format within the SI may be used to indicate TN coverages and frequency (ies) associated therewith. The present disclosure provides a method of expressing NTN-only coverages by using the IE format within the SI as they are, but expressing only the NTN-only coverages without information on the associated frequency (ies) or associated frequency information list.

By using the IE format used within the SI to indicate the TN coverages and information on the associated frequency (ies) as described above, an advantage can be achieved in which a separate flag bit does not need to identify whether an expressed area is a TN coverage or an NTN-only coverage. Additionally, there is an advantage that there is no need to use a separate IE format to express the NTN-only coverages.

### (5) Method of Determining a Case Where a TN Coverage and an NTN-Only Coverage Overlap Each Other

In the above description, the method for announcing TN coverages and the method for expressing NTN-only coverages have been described. In this case, a specific area configured as a TN coverage may be expressed as an area with overlapping NTN-only coverage(s). When a terminal communicating with an NTN receives two pieces of information that are contradicting with each other as described above, the terminal may be unable to decide whether it should attempt to connect to a TN or remain in the NTN.

In the present disclosure, for the case where a TN coverage and an NTN-only coverage overlap, the TN coverage may be determined as follows. According to the present disclosure, when a TN coverage and an NTN-only coverage overlap each other, the terminal may determine that the overlapping area is an NTN-only coverage. In other words, the terminal may determine that the overlapping area is not a TN coverage.

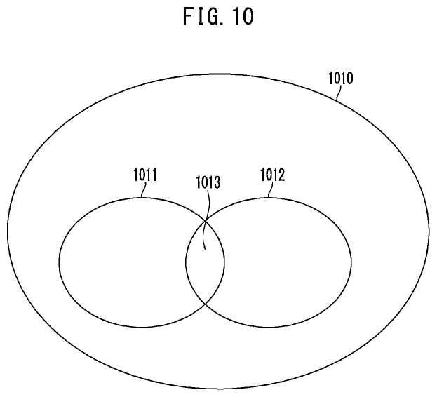

FIG. 10 is a conceptual diagram illustrating a case where a TN coverage included in an NTN coverage overlaps with a portion of an NTN-only coverage.

An NTN coverage 1010 may be a service coverage established by one satellite, and an NTN base station may transmit TN coverage information and NTN-only coverage information to the terminal using SI or other control information. FIG. 10 illustrates a TN coverage 1011 based on the TN coverage information and an NTN-only coverage 1012 based on the NTN-only coverage information. As illustrated in FIG. 10, there may be an overlapping coverage 1013 where the TN coverage 1011 based on the TN coverage information and the NTN-only coverage 1012 based on the NTN-only coverage information overlap.

According to exemplary embodiments of the present disclosure, the terminal may interpret (or determine) the overlapping coverage 1013 shown in the example in FIG. 10 as an NTN-only overage. In other words, the terminal may interpret (or determine) that the overlapping coverage 1013 is not a TN coverage.

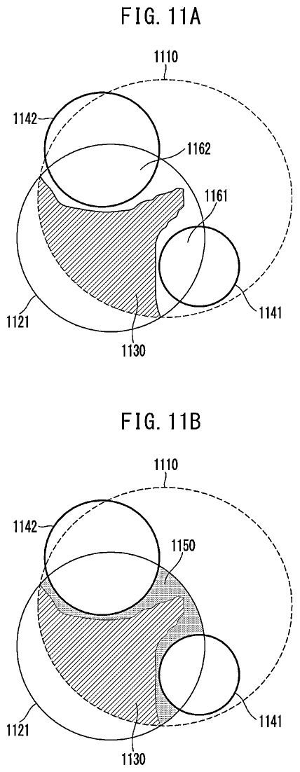

FIG. 11A is a conceptual diagram illustrating a TN coverage and an NTN-only coverage using circles, and FIG. 11B is a conceptual diagram illustrating an error coverage of FIG. 11A.

A TN coverage 1130 may be included within an NTN coverage 1110 covered by a satellite. In FIG. 11A, the TN coverage 1130 may be expressed using one circle as indicated by a reference numeral 1121. In other words, the TN coverage 1121 indicated by SI may have significant error coverages as previously described in FIG. 9A.

As described above, the present disclosure has described that information on NTN-only coverages is transmitted through SI. In FIG. 11A, NTN-only coverages 1141 and 1142 are expressed using respective circles. The NTN-only coverages 1141 and 1142 may have overlapping coverages 1161 and 1162 that overlap the TN coverage 1121. The terminal may determine that the overlapping coverages 1161 and 1162 are NTN-only coverages.

Referring to FIG. 11B, it can be seen that error coverage 1150 has been significantly reduced, unlike what was seen previously. In other words, the terminal may reduce the error coverage by determining the overlapping coverages 1161 and 1162 where the NTN-only coverages 1141 and 1142 and the TN coverage 1121 overlap as NTN coverages. In addition, although the present disclosure according to the example of FIGS. 11A and 11B uses three circles as in FIGS. 9E and 9F, the size of the error coverage is significantly reduced.

The example of FIGS. 11A and 11B may correspond to one special case. The example of FIGS. 11A and 11B may be a landform often observed on the ground, such as a cape, which refers to a geographically protruding land area that is only an actual TN coverage. Therefore, exemplary embodiments of the present disclosure have an advantage of being able to be used without increasing the maximum number of TN coverages that can be expressed in the new IE format or SI by using the expression method for NTN-only coverages.

Considering this, exemplary embodiments of the present disclosure have the flexibility to describe the TN coverages in more detail without changing the SI without providing additional information by overcoming the limitation on the number of circles and the geometric shape of circles. Due to the flexibility, the terminal has an advantage of being able to significantly reduce unnecessary measurements for TN cell reselection and significantly reduce power consumption.

### (6) TN Coverage Information Using Terminal-Dedicated Signaling

In the above description, the method of transmitting TN coverage information using SI broadcast by an NTN base station has been described. As described previously, there are limitations on the amount of information that can be included in SI broadcast by the NTN base station. Additionally, due to the nature of broadcasting, there are limitations on providing customized information that takes into account the circumstances of each terminal. Due to the limitations on the nature of SI, the accuracy of TN coverage information that can be broadcast using SI is bound to be limited. Exemplary embodiments of the present disclosure provide a method for the terminal to receive detailed TN coverage information from the base station using dedicated signaling transmitted for each terminal.

According to the present disclosure, when a terminal enters the RRC_IDLE mode, the NTN base station may provide TN coverage information to the terminal through dedicated signaling. In response, when the terminal enters the RRC_IDLE mode, the terminal receive the TN coverage information through dedicated signaling from the NTN base station.

In the description on types of information below, ‘combined’ may mean that determination is made by combining the TN coverage information received through SI broadcasting and the TN coverage information received through dedicated signaling for each terminal.

The TN coverage information that the terminal receives from the NTN base station may be some or all of the following information:
A distance to a boundary of the nearest TN coverage based on a location of the terminal entering the RRC_IDLE mode
A frequency associated with the nearest TN coverage based on the location of the terminal entering the RRC_IDLE mode
Additional TN coverage information combined with the TN coverage information broadcast by the SI
Additional NTN-only coverage information combined with the TN coverage information broadcast by the SI
Cell-specific information of TN neighboring cells that the terminal can reselect, including some or all of the following information:
   carrier frequency (ies)
   physical cell ID(s)
   Parameter(s) that allow the terminal to adjust a reselection priority for each cell even under the same conditions. For example, a correction value used when calculating a reference signal received power (RSRP) for each cell or a correction value used when calculating a reference signal received quality (RSRQ) for each cell
   Absolute reselection priority for each cell used during reselection
Some or all of the following information used for cell reselection by the terminal, even when they are not cell-specific information of neighboring cells:
White list configured as a list of physical cell IDs: list of physical cell IDs that can be reselected by the terminal
   White list configured as physical cell ID range(s): range of physical cell IDs that the terminal can reselect. This may be given in a form of information such as (starting physical cell ID, range)
   Black list configured as a list of physical cell IDs: list of physical cell IDs that cannot be reselected by the terminal.
   Black list configured as physical cell ID range(s): range of physical cell IDs that the terminal cannot reselect. This may be given in a form of information such as (starting physical cell ID, range)
   Absolute reselection priority for each carrier frequency or frequency band
   Priority correction parameter that allows the terminal to adjust a priority when reselecting each carrier frequency or frequency band

### (7) Determination of Whether to Initiate a Measurement Procedure for TN Cell Reselection

The terminal may be a terminal with a global navigation satellite system (GNSS) function. In other words, the terminal may identify its location using the GNSS function. The terminal may refer to a terminal with GNSS functionality. The terminal with GNSS functionality may receive signals from multiple satellites and measure (or calculate) its own location based on the signals received from multiple satellites. As a method for the terminal with GNSS functionality to measure or calculate its own location, one of the well-known methods may be used. Detailed description thereon is omitted in the present disclosure.

The terminal in the idle mode or inactive mode may receive broadcast information broadcast by the NTN base station. The terminal may obtain TN coverage information from the broadcast information based on the methods described above.

According to the present disclosure, the terminal may determine whether to perform a measurement initiation procedure for TN cell reselection using the TN coverage information obtained from the broadcast information and its own location information. One of the following methods may be used to determine whether to perform the measurement initiation procedure for TN cell reselection according to the present disclosure.

Method #1: If the terminal determines that its location is within a TN coverage based on the broadcast information, the terminal may perform the measurement initiation procedure for TN cell reselection.

Method #2: If the terminal determines that its location is not within a TN coverage based on the broadcast information, but is close to a TN coverage based on the broadcast information, the terminal may perform the measurement initiation procedure for TN cell reselection.

Method #2-1: The terminal may be determined to be close to a TN coverage according to the terminal's own criteria from an implementation perspective.

Method #2-2: The terminal may be determined to be close to a TN coverage when a distance between a boundary of the TN coverage and the terminal's location is equal to or less than a threshold distance received in advance from the network. The threshold distance may be obtained through broadcasting and/or dedicated signaling from the NTN base station on which the terminal is camped.

Method #3: When the condition of Method #1 is satisfied, and a cell reselection priority of a frequency included in TN frequency information is determined to be higher than an NTN cell on which the terminal is camped based on the broadcast information received from the

NTN base station, the terminal may perform the measurement initiation procedure for TN cell reselection.

Method #4: When the condition of Method #2 is satisfied, and a cell reselection priority of a frequency included in TN frequency information is determined to be higher than an NTN cell on which the terminal is camped based on the broadcast information received from the

NTN base station, the terminal may perform the measurement initiation procedure for TN cell reselection.

Method #5: Even if the conditions of all methods above are not satisfied, the measurement may be initiated at regular intervals.

### (8) Measurement Initiation Procedure for TN Cell Reselection

When a measurement initiation procedure for TN cell reselection is performed, the terminal may need information on TN neighboring cells that are measurement targets. The information on TN neighboring cells may include carrier frequency (ies), physical cell ID(s), etc.

When the terminal receives the information on TN neighboring cells to be measured through SI broadcast by an NTN base station, the terminal may obtain information on the TN neighboring cells that are the measurement targets from the received information. As previously described, the amount of information broadcast as SI is limited. Therefore, the terminal may not be able to receive information on TN neighboring cells to be measured through the SI broadcast by the NTN base station. Additionally, TN neighboring cell(s) indicated by the SI may not be actual neighboring cell(s) of the terminal. In other words, the terminal may not be included in a coverage of a TN neighboring cell indicated by the SI transmitted by the NTN base station.

Although the terminal can initiate measurement for TN cell reselection using the method according to the present disclosure, the terminal may not be able to perform effective measurement on actual TN neighboring cells. To solve this issue, the present disclosure provides a measurement initiation procedure for TN cell reselection for an NTN terminal in the idle mode as follows.

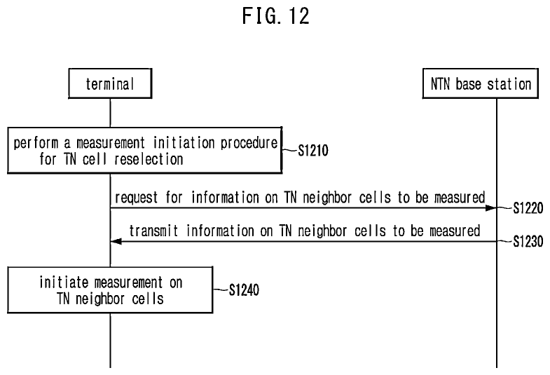

FIG. 12 is a sequence chart illustrating a measurement initiation procedure for TN cell reselection.

Referring to FIG. 12, a terminal and an NTN base station are illustrated. The NTN base station may be located on the ground or embedded in a satellite. If the NTN base station is located on the ground, the NTN base station may be connected to a satellite through a gateway. Each of the terminal and base station may include all or part of the components illustrated in FIG. 3. In addition, the terminal may further include a GNSS function or device for GNSS functionality, as described above. For example, the terminal may further include a satellite signal receiver capable of receiving signals from a plurality of satellites. The satellite signal receiver may be included in the transceiver 330 illustrated in FIG. 3. The terminal may further include a determination device for determining its location based on the signals received at the satellite signal receiver. The determination device may correspond to the processor 310. In addition, the terminal may further include additional devices for user convenience.

If the NTN base station is located on the ground, the gateway may include all or part of the components illustrated in FIG. 3. In addition, the gateway may further include additional components other than those illustrated in FIG. 3. For example, the gateway may further include an interface for communicating with the base station. The transceiver 330 configured in the gateway may be a device for performing wireless communication with the satellite.

If the NTN base station is located on the ground, the NTN base station may further include an interface device for connecting to the gateway in the configuration of FIG. 3. In addition, the NTN base station located on the ground may further include an interface for communicating with a core network or other base station devices.

In step S1210, the terminal may perform a measurement initiation procedure for TN cell reselection. Before performing the measurement initiation procedure, the terminal may determine whether to perform the measurement initiation procedure for TN cell reselection described in the clause (7) above. The measurement initiation procedure may be performed by one of the methods described in the clause (7).

When the measurement procedure for TN cell reselection is initiated, the terminal may transmit a signal requesting information on TN neighboring cells to be measured to the NTN base station on which it is camped in step S1220. In this case, the request signal may include information of a current location of the terminal. If the terminal is in the RRC idle mode or RRC inactive mode, the terminal may transition to the RRC connected mode to transmit the request signal to the NTN base station. The terminal may start a random access procedure with the NTN base station to transition to the RRC connected mode and transmit the request message to the NTN base station. When the terminal is in the RRC connected mode, the terminal may transmit the request signal to the NTN base station using an RRC layer message.

In step S1220, the NTN base station may receive from the terminal the request signal for TN neighboring cells to be measured. In response to the request in step S1220, in step S1230, the base station may transmit to the terminal information on TN neighboring cells that the terminal can reselect based on the location of the terminal that transmitted in the request signal. In this case, the location of the terminal may be indicated by the location information of the terminal included in the request signal. The information on TN neighboring cells that the terminal can reselect may include cell information below.

First, the information on TN neighboring cells that the terminal can reselect may be information on neighboring cells of a specific cell if the terminal is within a service coverage of the specific cell based on the current location of the terminal.

Second, the information on TN neighboring cells that the terminal can reselect may be information on cells that are close to the terminal if the terminal is not within the service coverage of the specific cell.

Information on reselectable TN neighboring cells included in response information may vary depending on the location of the terminal. In other words, information on reselectable TN neighboring cells may be different information for each terminal. Since information on reselectable TN neighboring cells is different information for each terminal, it may be referred to as UE-specific information.

In step S1230, the NTN base station may use an RRC layer message when transmitting a response signal to the terminal.

The terminal may receive the response signal from the NRN base station in step S1230. In this case, the received response signal may be an RRC layer message.

In step S1240, the terminal may initiate measurement on the corresponding cells based on the information on TN neighboring cells included in the received response signal.

### (9) TN Neighboring Cell Information Included in a Response in the Request-Response Procedure

In the request-response procedure described in FIG. 12, the information on reselectable TN neighboring cells, transmitted by the base station to the terminal in response to the terminal's request, may include at least one of the following cell-specific information for each neighboring cell.
Carrier frequency
Physical cell ID
Parameter(s) that allows the terminal to adjust a reselection priority for each cell even under the same conditions. For example, a correction value used when calculating an RSRP for each cell or a correction value used when calculating an RSRQ for each cell
Absolute reselection priority for each cell used during reselection

In addition, some or all of the following information used for cell reselection by the terminal may be include in the response signal of the base station, even when they are not cell-specific information of neighboring cells:
White list configured as a list of physical cell IDs: list of physical cell IDs that can be reselected by the terminal
White list configured as physical cell ID range(s): range of physical cell IDs that the terminal can reselect. This may be given in a form of information such as (starting physical cell ID, range)
Black list configured as a list of physical cell IDs: list of physical cell IDs that cannot be reselected by the terminal.
Black list configured as physical cell ID range(s): range of physical cell IDs that the terminal cannot reselect. This may be given in a form of information such as (starting physical cell ID, range)
Absolute reselection priority for each carrier frequency or frequency band
Priority correction parameter that allows the terminal to adjust a priority when reselecting each carrier frequency or frequency band

### (10) Measurement Initiation Conditions for Reselection in EMC

Previously, GEO satellites and moving satellites have been described. In case of a moving satellite, a cell coverage covered by the satellite may also move along with the movement of the satellite, and a cell of the moving satellite is referred to as an Earth-moving cell (EMC). In case of a terminal located in an EMC, if cell reselection is performed according to the method described above, unnecessary measurements for cell reselection may be made as described in FIGS. 7A to 7C. The present disclosure provides a method for avoiding unnecessary measurements for cell reselection in a terminal located in an EMC.

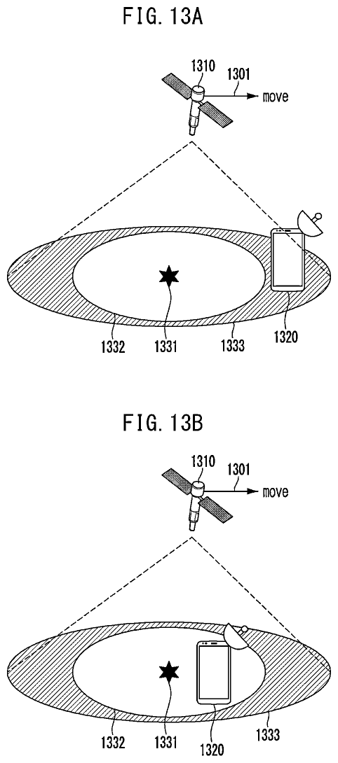

FIG. 13A is a conceptual diagram illustrating a terminal location at a first time in an NTN where a satellite moves, and FIG. 13B is a conceptual diagram illustrating a terminal location at a second time in the NTN where the satellite moves.

In FIGS. 13A and 13B, a direction of an arrow 1301 indicates a moving direction of a satellite 1310. As the satellite 1310 moves, an EMC 1333 may also move together. The satellite 1310 may provide information on a cell's reference location 1331 and threshold distance (e.g. threshold distance value) to a terminal 1320 using SIB19. The terminal 1320 may receive the SIB19 and obtain the cell's reference location 1331 and threshold distance from the SIB19. In FIGS. 13A and 13B, the reference location 1331 of the cell may be designated as a specific location within the cell covered by the satellite 1310.

A first service coverage 1332 may be determined by the threshold distance value provided by the SIB19. A second service coverage within a coverage 1333 of the cell, which does not overlap the first service coverage 1332, may generally correspond to a measurement condition region of the terminal 1320, as described above.

FIG. 13A illustrates a location of the terminal 1320 at a time t1, and FIG. 13B illustrates a location of the terminal 1320 at a time t2. Considering the moving direction 1301 of the satellite 1310, the time t2 may be later than the time t1.

According to the prior arts, the terminal 1320 at the time t1 may initiate measurement for TN cell reselection based on the distance-based measurement initiation scheme. However, the terminal may be actually located within the first service coverage 1332 at the time t2. This is because the EMC moves according to the moving direction of the satellite 1310. In other words, although the terminal 1320 initiates measurement for TN cell reselection at the time t1, the terminal may actually approach a center of the cell at the time t2. Therefore, the measurement operation initiated by the terminal 1320 for TN cell reselection at the time t1 may be an unnecessary measurement.

This phenomenon may occur because the distance-based measurement initiation scheme has been introduced considering only cells with fixed cell coverages (Earth-fixed cells or quasi-Earth-fixed cells) in non-terrestrial networks. Therefore, if the distance-based measurement initiation scheme is applied to the EMC as is, there may be a problem of initiating unnecessary measurements as described in FIGS. 13A and 13B. Accordingly, the present disclosure provides a distance-based measurement initiation scheme that can avoid unnecessary measurements in EMC.

In exemplary embodiments of the present disclosure, the terminal may determine whether to initiate distance-based measurement using a prediction method of the terminal. The prediction method of the terminal may use the location of the terminal, epoch time included in the SIB 19 broadcast by the moving satellite 1310, and ephemeris information of the satellite. The terminal 1320 may predict a distance between a reference location of the cell 1331 and a location of the terminal 1320 after a certain time based on the prediction. The satellite's ephemeris information may include information on the satellite's moving direction. In addition, as described above, system information broadcast by the satellite 1310 may include information on the reference location 1331 and threshold distance. The terminal 1320 may have a function of identifying a current time and its location. For example, the terminal 1320 may have a GNSS device, so the terminal is able to know the current time and its own location. Therefore, the terminal 1320 may calculate a distance between the reference location 1331 at a time of calculation and its location at the time of calculation. The terminal 1320 may check whether the calculated distance between the reference location 1331 and the terminal 1320 at the time of calculation is greater than or equal to the threshold distance.

If the calculated distance is greater than or equal to the threshold distance, the terminal 1320 may determine whether to initiation measurement for TN cell reselection based on the satellite's ephemeris information. In other words, the terminal 1320 may predict the terminal's location within the cell after a certain time period based on the satellite's ephemeris information. Based on the above-described prediction, even when the terminal 1320 is currently located outside the threshold distance from the reference location within the EMC 1333, if it is expected that the terminal is to move within the threshold distance from the reference location within the same EMC due to the movement of the satellite 1310, the terminal may not initiate measurements for TN cell reselection. When the terminal 1320 performs measurements for TN cell reselection based on the prediction and distance-based measurement initiation scheme, unnecessary measurements can be reduced.

The operations of the method according to the exemplary embodiment of the present disclosure can be implemented as a computer readable program or code in a computer readable recording medium. The computer readable recording medium may include all kinds of recording apparatus for storing data which can be read by a computer system. Furthermore, the computer readable recording medium may store and execute programs or codes which can be distributed in computer systems connected through a network and read through computers in a distributed manner.

The computer readable recording medium may include a hardware apparatus which is specifically configured to store and execute a program command, such as a ROM, RAM or flash memory. The program command may include not only machine language codes created by a compiler, but also high-level language codes which can be executed by a computer using an interpreter.

Although some aspects of the present disclosure have been described in the context of the apparatus, the aspects may indicate the corresponding descriptions according to the method, and the blocks or apparatus may correspond to the steps of the method or the features of the steps. Similarly, the aspects described in the context of the method may be expressed as the features of the corresponding blocks or items or the corresponding apparatus. Some or all of the steps of the method may be executed by (or using) a hardware apparatus such as a microprocessor, a programmable computer or an electronic circuit. In some embodiments, one or more of the most important steps of the method may be executed by such an apparatus.

In some exemplary embodiments, a programmable logic device such as a field-programmable gate array may be used to perform some or all of functions of the methods described herein. In some exemplary embodiments, the field-programmable gate array may be operated with a microprocessor to perform one of the methods described herein. In general, the methods are preferably performed by a certain hardware device.

The description of the disclosure is merely exemplary in nature and, thus, variations that do not depart from the substance of the disclosure are intended to be within the scope of the disclosure. Such variations are not to be regarded as a departure from the spirit and scope of the disclosure. Thus, it will be understood by those of ordinary skill in the art that various changes in form and details may be made without departing from the spirit and scope as defined by the following claims.

What is claimed is:

1. A method of a terminal, comprising:
acquiring, from a non-terrestrial network (NTN) base station, system information (SI) including information indicating either a (quasi-) Earth-fixed cell or an Earth-moving cell (EMC);
in response to the SI indicating an EMC, calculating a first distance between a location of the terminal and a reference location; and
determining whether to perform measurement for cell reselection based on a comparison result between the first distance and a threshold distance included in the SI and ephemeris information of a satellite included in the SI.

2. The method according to claim 1, wherein in the determining of whether to perform measurement for cell reselection, if the first distance is determined to be longer than the threshold distance according to the comparison result but is predicted to decrease based on the ephemeris information of the satellite, the terminal determines not to perform the measurement for cell reselection.

3. The method according to claim 1, wherein in the determining of whether to perform measurement for cell reselection, if the first distance is determined to be longer than the threshold distance according to the comparison result and is predicted to increase based on the ephemeris information of the satellite, the terminal determines to perform the measurement for cell reselection.

4. The method according to claim 1, further comprising:
obtaining terrestrial network (TN) coverage information included in the SI; and
determining a TN coverage satisfying a first condition among TN coverages indicated by the TN coverage information as an NTN-only coverage,
wherein the first condition is that frequency information associated with the TN coverage information does not exist, or a frequency information list associated with the TN coverage information is empty.

5. The method according to claim 4, wherein when the SI includes information on a first TN coverage and a second TN coverage, the second TN coverage is determined as the NTN-only coverage, and the terminal is located in an overlapping coverage where the first TN coverage and the second TN coverage overlap, the overlapping coverage is determined to be the NTN-only coverage.

6. The method according to claim 1, further comprising:
obtaining terrestrial network (TN) coverage information included in the SI;
determining whether a measurement initiation condition for TN cell reselection is satisfied based on the SI and the location of the terminal; and
in response to determining that the measurement initiation condition is satisfied, performing measurement on TN cells based on the obtained TN coverage information and frequency information associated with TN coverage(s) indicated by the obtained TN coverage information.

7. The method according to claim 6, further comprising:
when the TN coverage information indicates each of a first TN coverage and a second TN coverage, and the location of the terminal is within an overlapping coverage of the first TN coverage and the second TN coverage, obtaining first additional information associated with the first TN coverage and second additional information associated with the second TN coverage; and
configuring to use only information common to the first additional information and the second additional information in the overlapping coverage.

8. The method according to claim 7, wherein each of the first additional information and the second additional information includes one of frequency information, a frequency list, a frequency band, or a frequency band list.

9. The method according to claim 1, further comprising:
obtaining terrestrial network (TN) coverage information included in the SI;
in response to that a cell selection condition is satisfied based on the TN coverage information, requesting additional information from the NTN base station;
receiving the additional information from the NTN base station; and
performing measurement for cell reselection based on the TN coverage information and the additional information.

10. A method of a non-terrestrial network (NTN) base station, comprising:
broadcasting system information (SI) including information indicating either a (quasi-) Earth-fixed cell or an Earth-moving cell (EMC);
receiving, from a terminal, a first message requesting terrestrial network (TN) neighboring cell information including location information of the terminal;
generating a second message including the TN neighboring cell information based on the location information of the terminal; and
transmitting the second message to the terminal.

11. The method according to claim 10, wherein the SI further includes information on a reference location of the satellite, information on a threshold distance, ephemeris information of the satellite, TN coverage information, and additional information associated with TN coverages indicated by the TN coverage information, and
wherein the TN coverage information indicates a first TN coverage and a second TN coverage, and the additional information associated with the TN coverages includes first additional information associated with the first TN coverage and second additional information associated with the second TN coverage.

12. The method according to claim 11, wherein each of the first additional information and the second additional information includes one of frequency information, a frequency list, a frequency band, or a frequency band list.

13. A terminal comprising a processor, wherein the processor causes the terminal to perform:
acquiring, from a non-terrestrial network (NTN) base station, system information (SI) including information indicating either a (quasi-) Earth-fixed cell or an Earth-moving cell (EMC);
in response to the SI indicating an EMC, calculating a first distance between a location of the terminal and a reference location; and
determining whether to perform measurement for cell reselection based on a comparison result between the first distance and a threshold distance included in the SI and ephemeris information of a satellite included in the SI.

14. The terminal according to claim 13,
wherein in the determining of whether to perform measurement for cell reselection, if the first distance is determined to be longer than the threshold distance according to the comparison result but is predicted to decrease based on the ephemeris information of the satellite, the processor causes the terminal to perform: determining not to perform the measurement for cell reselection, and
wherein in the determining of whether to perform measurement for cell reselection, if the first distance is determined to be longer than the threshold distance according to the comparison result and is predicted to increase based on the ephemeris information of the satellite, the processor causes the terminal to perform: determining to perform the measurement for cell reselection.

15. The terminal according to claim 13, wherein the processor further causes the terminal to perform:
obtaining terrestrial network (TN) coverage information included in the SI; and
determining a TN coverage satisfying a first condition among TN coverages indicated by the TN coverage information as an NTN-only coverage,
wherein the first condition is that frequency information associated with the TN coverage information does not exist, or a frequency information list associated with the TN coverage information is empty.

16. The terminal according to claim 15, wherein when the SI includes information on a first TN coverage and a second TN coverage, the second TN coverage is determined as the NTN-only coverage, and the terminal is located in an overlapping coverage where the first TN coverage and the second TN coverage overlap, the overlapping coverage is determined to be the NTN-only coverage.

17. The terminal according to claim 13, wherein the processor further causes the terminal to perform:
obtaining terrestrial network (TN) coverage information included in the SI;
determining whether a measurement initiation condition for TN cell reselection is satisfied based on the SI and the location of the terminal; and
in response to determining that the measurement initiation condition is satisfied, performing measurement on TN cells based on the obtained TN coverage information and frequency information associated with TN coverage(s) indicated by the obtained TN coverage information.

18. The terminal according to claim 17, wherein the processor further causes the terminal to perform:
when the TN coverage information indicates each of a first TN coverage and a second TN coverage, and the location of the terminal is within an overlapping coverage of the first TN coverage and the second TN coverage, obtaining first additional information associated with the first TN coverage and second additional information associated with the second TN coverage; and
using only information common to the first additional information and the second additional information in the overlapping coverage.

19. The terminal according to claim 18, wherein each of the first additional information and the second additional information includes one of frequency information, a frequency list, a frequency band, or a frequency band list.

20. The method according to claim 13, wherein the processor further causes the terminal to perform:
obtaining terrestrial network (TN) coverage information included in the SI;
in response to that a cell selection condition is satisfied based on the TN coverage information, requesting additional information from the NTN base station;
receiving the additional information from the NTN base station; and
performing measurement for cell reselection based on the TN coverage information and the additional information.
